(19) United States
(12) Patent Application Publication
(10) Pub. No.: US 2006/0240314 A1
(43) Pub. Date: Oct. 26, 2006

(54) Electrode for fuel cell and solid oxide fuel cell using the same

(75) Inventors: Dong Song, Kanagawa-ken (JP); Masaharu Hatano, Kanagawa-ken (JP)

Correspondence Address: FOLEY AND LARDNER LLP;SUITE 500, 3000 K STREET NW, WASHINGTON, DC, 20007, US

(73) Assignee: Nissan Motor Co., Ltd.

(21) Appl. No.: 10/554,313

(22) PCT Filed: Apr. 27, 2004
(86) PCT No.: PCT/JP04/06092

§ 371 Date: Oct. 24, 2005

(30) Foreign Application Priority Data
Jun. 10, 2003 (JP) 2003-164904

(51) Int. Cl. H01M 4/86; H01M 8/12

(52) U.S. Cl. 429/44; 429/30

(57) ABSTRACT

An electrode (1) for fuel cell according to the present invention comprises electron-conducting particles (5), and fibrous oxide particles (3). In the electrode (1), the ratio represented by the following formula (I) is within a range from 5 to 25, and the ratio represented by the following formula (II) is within a range from 1 to 10: average major axis of the oxide particles (3)/average major axis of the electron-conducting particles (5) (I), and thickness of the electrode (1)/average major axis of the oxide particles (3) (II). A large number of oxygen ion-conducting paths can thereby be formed in the electrode (1) to increase three phase zones, thus permitting electrons to be efficiently taken out therefrom. Further, a fuel cell (10) with high output and excellent power generation efficiency can be obtained by using the electrode (1) of the present invention.

### TECHNICAL FIELD

The present invention relates to an electrode for fuel cell and a solid oxide fuel cell using the same. The present invention relates in particular to an electrode for fuel cell, which is excellent in electrode performance with many three phase zones and high porosity in the electrode, as well as a solid oxide fuel cell using the same.

### BACKGROUND ART

In recent years, a fuel cell attracts attention as an energy source with high power generation efficiency, hardly generating toxic exhaust gas and being environmentally friendly.

Among various kinds of fuel cells, a solid oxide fuel cell (SOFC) uses an oxygen ion-conducting solid electrolyte such as yttria stabilized zirconia (YSZ) as an electrolyte, both sides of which are provided with gas-permeable electrodes respectively. SOFC is constituted to generate electricity with the solid electrolyte as a partition wall by supplying a fuel gas such as hydrogen and a hydrocarbon to one electrode and an oxidizing gas such as an oxygen gas and air to the other electrode.

As the conventional SOFC, there is proposed a SOFC using an electrolyte including a sintered material consisting of fibrous particles of YSZ as a matrix material whose pores are impregnated with copper particles or samaria doped ceria particles (refer to Applied Catalysis A: General 200 (2000) 55-61).

As the conventional electrode, there is known a cermet electrode using a mixed material consisting of a metal and an oxide wherein the difference in particle diameter therebetween is high. This electrode is characterized by suppressing aggregation of nickel to a certain degree by adding an oxide material to nickel particles.

### DISCLOSURE OF THE INVENTION

In the conventional SOFC, however, the sintered material consisting of fibrous particles of YSZ is merely used as an electrolyte, and is not used for the purpose of increasing three phase zones (sites where electrons, ions and a gaseous phase are contacted with one another) as reaction sites.

Further, metal and oxide particles are dispersed in the cermet electrode described above, and ion-conducting paths of the oxide are not sufficiently formed, thus limiting oxygen ion-conducting paths and decreasing the reaction rate in some cases. In the cermet electrode, the reaction sites are reduced in some cases because of limitation of the oxygen ion-conducting paths. On the other hand, it is difficult to allow oxide particles to form desired oxygen ion-conducting paths by merely mixing the spherical metal particles with the oxide particles.

The present invention has been accomplished in order to solve the above problem. It is an object of the present invention to provide an electrode for fuel cell having sufficient oxygen ion-conducting paths and a solid oxide fuel cell using the same.

The first aspect of the present invention provides an electrode for fuel cell, comprising: electron-conducting particles; and fibrous oxide particles, wherein the ratio represented by the following formula (I) is within a range from 5 to 25, and the ratio represented by the following formula (II) is within a range from 1 to 10: average major axis of the oxide particles/average major axis of the electron-conducting particles (I), and thickness of the electrode/average major axis of the oxide particles (II).

The second aspect of the present invention provides a solid oxide fuel cell comprising: an air electrode layer; a fuel electrode layer including electron-conducting particles and fibrous oxide particles; and a solid electrolyte layer sandwiched between the air electrode layer and the fuel electrode layer, wherein the ratio represented by the following formula (I) is within a range from 5 to 25, and the ratio represented by the following formula (II) is within a range from 1 to 10: average major axis of the oxide particles/average major axis of the electron-conducting particles (I), and thickness of the electrode/average major axis of the oxide particles (II).

### BRIEF DESCRIPTION OF THE DRAWINGS

FIG. 1 is a SEM (scanning electron microscope) view of an electrode for fuel cell according to the present invention;

FIG. 2 is a longitudinal sectional view schematically showing oxide particles covered with electron-conducting particles;

FIG. 3 is a schematic view showing a single cell using the electrode for fuel cell according to the present invention; and

FIG. 4 is a table showing the results of Examples and a Comparative Example.

### BEST MODE FOR CARRYING OUT THE INVENTION

The electrode for fuel cell according to the present invention is described hereinafter in more detail with reference to the drawings. In the present invention, one surface of a layer such as an electrode layer and a support is referred to as “surface” and the other surface as “reverse surface” for convenience of explanation, but the both surfaces are equivalent elements, and thus the constitution wherein the surface is substituted for reverse surface, and vice versa, falls under the scope of the present invention.

The electrode for fuel cell according to the present invention includes electron-conducting particles and fibrous oxide particles. Further, the ratio represented by the following formula (I) is within a range from 5 to 25, and the ratio represented by the following formula (II) is within a range from 1 to 10:

average major axis of the oxide particles/average major axis of the electron-conducting particles (I),
thickness of an electrode/average major axis of the oxide particles (II).

As used herein, the “major axis of the electron-conducting particle” refers to the size of the largest diameter of the electron-conducting particle. The “major axis of the oxide particle” refers to the size of the largest diameter of the fibrous oxide particle.

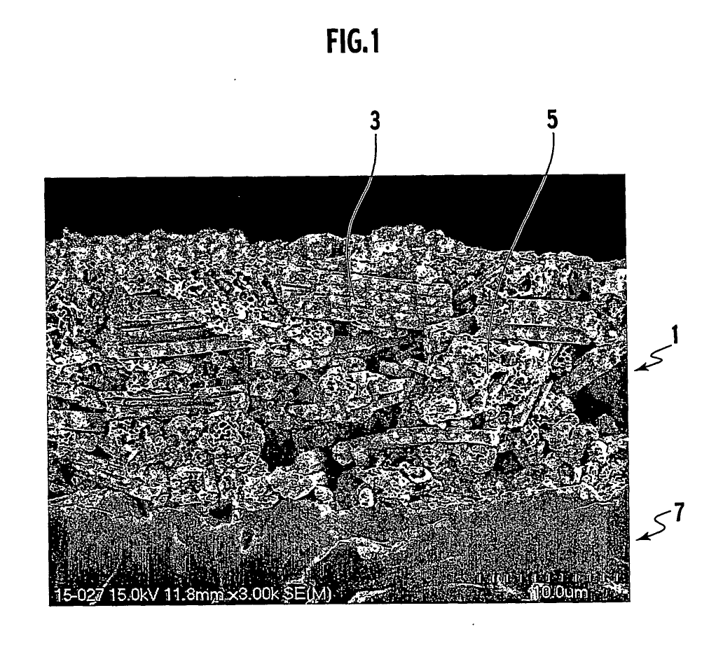

By constituting the electrode for fuel cell as described above, the electrode 1 for fuel cell according to the present invention as shown in FIG. 1 can be obtained. The electrode 1 makes use of fibrous particles as oxygen ion-conducting oxide particles 3, thus efficiently conducting oxygen ions. Under the conditions shown in formulas (I) and (II) above, the orientation of the oxide particles 3 comes to be readily in the approximately same direction. Accordingly, the fibrous oxide particles 3 are contacted with one another at their terminus and sides as shown in FIG. 1, to form oxygen ion-conducting paths. The three phase zones of the electrode as a reaction site are thereby increased to allow electrons to be efficiently taken out therefrom. The oxide particles 3 form oxygen ion-conducting paths through which oxygen ions are diffused to the whole of the electrode to increase the reactivity between fuel gas and oxygen ions. Further, the oxide particles 3 are in a fibrous form so that the electron-conducing particles 5 are well diffused and hardly aggregated, thus increasing the porosity of the formed electrode to permit the fuel gas to be efficiently diffused in the electrode. The “three phase zone” refers to a site wherein gas, electrons and oxygen ions are contacted with one another.

When the ratio represented by the formula (I) is lower than 5, the electron-conducting particles 5 are too large, and thus the spaces among the oxide particles 3 are so broad that oxygen ion-conducting paths cannot be sufficiently formed and the resulting electrode is deficient in the three phase zone. When the ratio is higher than 25, the oxide particles 3 are too large, and thus the spaces among the electron-conducting particles 5 are so broad as to prevent formation of electron-conducting paths. Further, when the ratio represented by the formula (II) is lower than 1, the electron-conducting paths are not sufficiently formed. When the ratio is higher than 10, the orientation of the oxide particles 3 is not in the approximately same direction, and the ion-conducting paths cannot be sufficiently formed.

The electron-conducting particles 5 can make use of electron-conducting metals such as nickel (Ni), copper (Cu), ruthenium (Ru), platinum (Pt), or cermets thereof, for example, Ni-YSZ, Cu-YSZ, Ru-YSZ and Pt-YSZ. These form paths for conducting electrons generated by the fuel electrode reaction so that as the electrical conductivity is increased, a fuel cell having higher performance with a reduction in the internal resistance of the cell can be produced.

The oxide particles 3 preferably have oxygen ion conductivity. The oxide particles can thereby effectively act as an oxygen ion-conducting path in the electrode. The oxide particles 3 include oxide materials such as 8 mol % yttria stabilized zirconia, substituted lanthanum gallates (for example LaSrGaMgO, LaSrGaMgCoO), ceria, samaria doped ceria (SDC), and yttria doped ceria (YDC).

When a single cell for fuel cell is prepared by using the electrode of the present invention, the oxide particles 3 are desirably made of the same material as that of an electrolyte layer 7. Interfacial exfoliation due to a difference in thermal expansion from the electrolyte layer 7 and generation of heat in the interface due to a difference in oxygen ion conductivity is thereby prevented, thus improving the performance of the electrode.

The maximum diameter of the oxide particles 3, that is, the maximum diameter of the oxide particles 3 in a section almost perpendicular to the major axis thereof is particularly preferably within a range from 0.5 to 5 μm. In this range, the rate of diffusion of oxygen ions in the electrode is easily increased. When the maximum diameter is smaller than 0.5 μm, the mechanical strength of the oxide particles 3 is easily lowered. When the maximum diameter is greater than 5 μm, the specific surface area of the whole electrode is easily reduced.

When the maximum diameter of the oxide particles 3 in a perpendicular section is too large, the distance in which oxygen ions are diffused in the oxide particles 3 is increased, and thus the reaction rate of the electrode is decreased, so that the output of the cell is lowered.

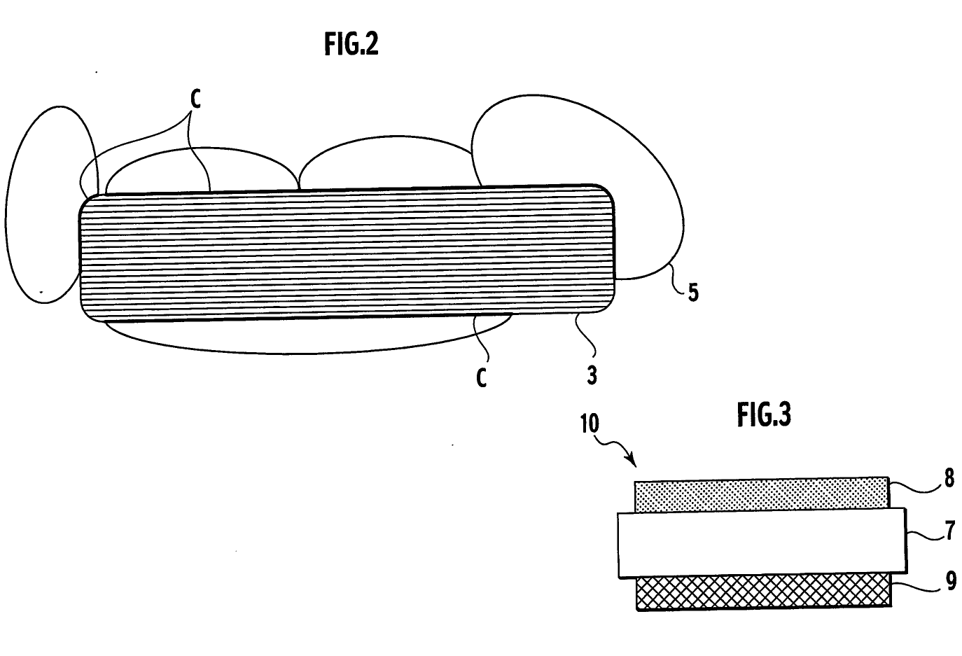

Preferably, the electron-conducting particles 5 are metal particles with which 70 to 95% of surface of the oxide particles 3 is covered to form a porous metal layer. In this range of coverage degree, the three phase zone where the electrode reaction occurs is increased, and the electrode reaction rate is increased. The three phase zone can be increased for example by contacting electron-conducting particles such as nickel in a coverage degree of 70 to 95% with the surface of the fibrous oxide particles. When the coverage degree is less than 70%, the contact interface is small thus reducing the reaction site. When the coverage degree is greater than 95%, the contact surface of gaseous phase is reduced. As shown in FIG. 2, the coverage degree of the surface is defined as the ratio of length of a contact part C where the oxide particle 3 is contacted with the electron-conducting particles 5, to length of the outer periphery of a longitudinal section of the fibrous oxide particle 3. The coverage degree of the surface can be determined by observation under SEM. FIG. 2 is a schematic illustration of one example of the oxide particle 3 covered with the electron-conducting particles 5, and not all the oxide particles 3 are covered like in FIG. 2.

The thickness of the porous metal layer is desirably within a range of 0.1 to 1 μm from the viewpoint of permeability of gas species.

The thickness of the electrode 1 for fuel cell according to the present invention is preferably within a range from 5 to 100 μm. The interfacial conductivity of gas is thereby increased, and resistance to gas diffusion is reduced. When the thickness is less than 5 μm, the resistance may be increased, so that the interfacial conductivity of electrons is reduced. When the thickness is greater than 100 μm, resistance to gas diffusion may be increased, so that cell output is reduced.

The single cell for solid oxide fuel cell according to the present invention and the method of producing the same are described in more detail. As shown in FIG. 3, a single cell 10 of the present invention includes a solid electrolyte layer 7 sandwiched between a fuel electrode layer 8 and an air electrode layer 9. The fuel electrode layer 8 can make use of the electrode 1 for fuel cell according to the present invention. The air electrode layer 9 can make use of La₁₋ₓSrₓMnO₃ (LSM), La₁₋ₓSrₓCoO₃ (LSC), platinum (Pt) and silver (Ag). The solid electrolyte layer 7 is necessary for exhibiting a function of generating electricity, and its usable materials include, but are not limited to, oxygen ion-conducting materials such as stabilized zirconia containing a solid solution of neodymium oxide (Nd₂O₃), samarium oxide (Sm₂O₃), yttria (Y₂O₃) and gadolinium oxide (Gd₂O₃), a ceria (CeO₂)-based solid solution, bismuth oxide and LaGaO₃, and strontium and magnesium doped lanthanum gallate (LSGM).

The single cell 10 including the solid electrolyte layer 7, the fuel electrode layer 8, and the air electrode layer 9 can be formed on a substrate such as silicon. Further, the substrate material is not limited, and either of an electroconductive substrate or an insulating substrate can be adopted, and a glass substrate and a metal substrate can also be used.

In production of the single cell 10, the fuel electrode layer 8 is obtained in such a manner that the oxide particles 3 are covered with the electron-conducting particles 5 by an impregnation method, a sol-gel method, a plating method, a sputtering method, or an arbitrary combination of these methods. The oxide particles 3 and the electron-conducting particles 5 are mixed with one another more uniformly by these methods than by mechanical mixing with a triple roll mill or the like, thus increasing the contact area between the surface of the oxide particles 3 and the electron-conducting particles 5. Accordingly, the resulting single cell 10 has many three phase zones as the reaction site.

The electrode layer (fuel electrode layer 8) is baked at 1100 to 1400° C. The interface between the electrode and the electrolyte can thereby be maintained with excellent adhesiveness therebetween, and the porosity of the electrode can also be well maintained. When the baking temperature is lower than 1100° C., the interface between the electrode and the electrolyte is poor in adhesiveness therebetween, and the interfacial resistance is increased. When the baking temperature is higher than 1400° C., the materials are diffused to form a heterogeneous phase in the interface between the electrode and the electrolyte, and the interfacial resistance is increased. Further, the porosity of the electrode may be lowered by high-temperature baking.

An adhesive layer capable of improving adhesiveness in connecting regions, a reinforcing layer capable of relaxing thermal stress on the solid electrolyte layer 7 and the like, or mechanical stress on the film can be arranged if necessary as an interlayer between the solid electrolyte layer 7 and the fuel electrode layer 8 or between the solid electrolyte layer 7 and the air electrode layer 9.

Hereinafter, the present invention is described in more detail with reference to the Examples and Comparative Example, but the present invention is not limited to these examples.

### EXAMPLE 1

First, SDC having an average major axis of 5 μm was added as fibrous oxide particles to a nitrate solution containing nickel having an average particle diameter of 1.2 μm, then impregnated with the solution for 20 hours and heat-treated at 600° C. to give mixed Ni-SDC particles.

The resulting NiO-SDC powder was mixed with ethyl cellulose (binder) and turpentine oil (solvent) and regulated such that the solid content was 80%, to give an electrode paste. An electrolyte (φ14×0.3t) including LSGM was covered thereon with this electrode paste by a screen printing method and sintered at 120° C. to form a fuel electrode. The thickness of the fuel electrode was 20 μm. The reverse surface of the electrolyte was covered with Sm_{0.5}Sr_{0.5}CoO₂ (SSC) to form an air electrode thereon to give a single cell.

### EXAMPLES 2 to 6

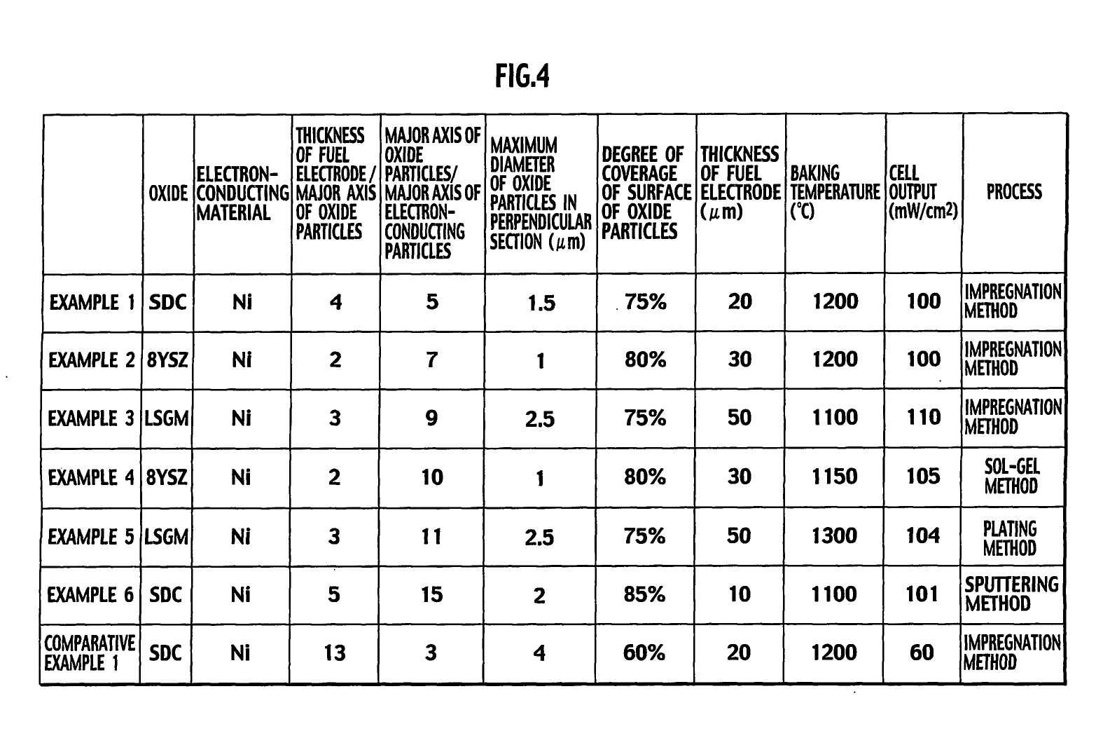

As shown in FIG. 4, the type and size of the electron-conducting particles and fibrous oxide particles were changed. The method of producing the fuel electrode was also changed as shown in FIG. 4. Except for these changes, the same procedure as in Example 1 was repeated to prepare a single cell.

### COMPARATIVE EXAMPLE 1

A single cell was prepared by repeating the same procedure as in Example 1 except that the thickness of the fuel electrode/major axis of the oxide particles was 13, the maximum diameter of the oxide particles in a section almost perpendicular to the major axis thereof was 4 μm, and the average particle diameter of the nickel particles was 1 μm.

The electricity generation of each single cell obtained in the examples was evaluated at 600° C. in H₂ and humidification of 5%. As shown in FIG. 4, the output of each single cell obtained in Examples 1 to 6 was 100 mW·cm⁻² or more, but the output of the single cell in Comparative Example 1 was 60 mW·cm⁻².

The entire content of a Japanese Patent Application No. P2003-164904 with a filing date of Jun. 10, 2003 is herein incorporated by reference.

Although the invention has been described above by reference to certain embodiments of the invention, the invention is not limited to the embodiments described above will occur to these skilled in the art, in light of the teachings. The scope of the invention is defined with reference to the following claims.

### INDUSTRIAL APPLICABILITY

According to the present invention as described in detail, the electrode for fuel cell according to the present invention includes electron-conducting particles and fibrous oxide particles, and is constituted such that the ratio represented by the formula (I) above is within a range from 5 to 25, and the ratio represented by the formula (II) above is within a range from 1 to 10. A large number of oxygen ion-conducting paths can thereby be formed in the electrode to increase three phase zones, thus permitting electrons to be efficiently taken out therefrom. Further, a fuel cell with high output and excellent power generation efficiency can be obtained by using the electrode of the present invention.

1. An electrode for fuel cell, comprising:
electron-conducting particles; and
fibrous oxide particles,
wherein the ratio represented by the following formula (I) is within a range from 5 to 25, and the ratio represented by the following formula (II) is within a range from 1 to 10:
average major axis of the oxide particles/average major axis of the electron-conducting particles (I), and
thickness of the electrode/average major axis of the oxide particles (II).

2. An electrode for fuel cell according to claim 1,
wherein the oxide particles have oxygen ion conductivity.

3. An electrode for fuel cell according to claim 1,
wherein the oxide particles form an oxygen ion-conducting path.

4. An electrode for fuel cell according to claim 1,
wherein the maximum diameter of the oxide particle in a section almost perpendicular to the major axis thereof is within a range from 0.5 to 5 μm.

5. An electrode for fuel cell according to claim 1,
wherein the electron-conducting particles are metal particles with which 70 to 95% of surface of the oxide particles is covered to form a porous metal layer.

6. An electrode for fuel cell according to claim 1,
wherein the thickness of the electrode is within a range from 5 to 100 μm.

7. A solid oxide fuel cell comprising:
an air electrode layer;
a fuel electrode layer including electron-conducting particles and fibrous oxide particles; and
a solid electrolyte layer sandwiched between the air electrode layer and the fuel electrode layer,
wherein the ratio represented by the following formula (I) is within a range from 5 to 25, and the ratio represented by the following formula (II) is within a range from 1 to 10:
average major axis of the oxide particles/average major axis of the electron-conducting particles (I), and
thickness of the electrode/average major axis of the oxide particles (II).

8. A solid oxide fuel cell according to claim 7,
wherein the oxygen particles are covered thereon with the electron-conducting particles by at least one technique selected from the group consisting of an impregnation method, a sol-gel method, a plating method and a sputtering method.

9. A solid oxide fuel cell according to claim 7,
wherein the fuel electrode layer is baked at 1100 to 1400° C.
